(19) United States
(12) Patent Application Publication
(10) Pub. No.: US 2025/0385040 A1
(43) Pub. Date: Dec. 18, 2025

(54) ELECTROMAGNETIC COIL, ELECTROMAGNETIC CLUTCH PROVIDED WITH THIS ELECTROMAGNETIC COIL, AND METHOD FOR PRODUCING THIS ELECTROMAGNETIC COIL

(71) Applicant: Valeo Japan Co., Ltd, Saitama (JP)

(72) Inventor: Nicolas Pluy, Rayong (TH)

(73) Assignee: Valeo Japan Co., Ltd, Saitama (JP)

(21) Appl. No.: 18/878,365

(22) PCT Filed: Jun. 16, 2023
(86) PCT No.: PCT/JP2023/022378

§ 371 Date: Dec. 23, 2024

(30) Foreign Application Priority Data
Jun. 23, 2022 (JP) 2022-100923

(51) Int. Cl. H01F 27/32; F16D 27/108; H01F 41/12

(52) U.S. Cl. CPC H01F 27/327; F16D 27/108; H01F 41/127

(57) ABSTRACT

An electromagnetic coil includes a magnetic coil case that has an annular storage groove; a bobbinless coil that is directly contained in the storage groove; a cover body that covers the entirety of the bobbinless coil, while having stretchability and resin impregnation ability; and an electrical insulating layer that is configured from an electrically insulating thermosetting resin, with which the cover body is impregnated, so as to cover the surface of the bobbinless coil.

### TECHNICAL FIELD

The present invention relates to improvements to an electromagnetic coil, an electromagnetic clutch comprising the electromagnetic coil, and a method for producing the electromagnetic coil.

### BACKGROUND ART

Electromagnetic coils are provided in various types of electromagnetic devices such as electromagnetic clutches and are also referred to as excitation coils. For example, an electromagnetic coil such as this is known from the technology in Patent Document 1 (see FIG. 1 and paragraph [0023]).

In the electromagnetic coil which is known from Patent Document 1, a coil bobbin on which a coil is wound is accommodated in an accommodating groove in a coil case (corresponding to an annular groove in a coil accommodating holder), and the coil bobbin and the coil are covered and fixed in the accommodating groove by a molding resin.

### PRIOR ART DOCUMENTS

### Patent Documents

Patent Document 1: JP 2020-085173 A

### SUMMARY OF THE INVENTION

### Problems to be Solved by the Invention

Recent years have seen the need to reduce the size and weight of electromagnetic coils provided in electromagnetic devices, from the point of view of reducing the size and the weight of the electromagnetic devices. However, the electromagnetic coil which is known from Patent Document 1 has a configuration in which the coil bobbin and the coil are molded in the accommodating groove by a layer of the molding resin, so there are limits to reducing the size and weight.

The present invention has been devised in order to solve the problems above, and the objective thereof lies in providing technology enabling a reduction in the size and the weight of an electromagnetic coil.

### Means for Solving the Problems

The reference symbols used in the appended drawings are added in parentheses in the description below in order to make the present invention easier to understand, but this does not limit the present invention to the forms depicted.

In a first aspect, the present invention provides an electromagnetic coil (10) comprising:

a magnetic coil case (20) having an annular accommodating groove (24);
a bobbinless coil (30) accommodated directly in the accommodating groove (24);
a stretchable and resin-impregnatable covering (40) that covers the whole of the bobbinless coil (30); and
an electrical insulation layer (50) which is formed by an electrically-insulating thermosetting resin impregnating the covering (40), and covers a surface of the bobbinless coil (30).

In a second aspect, the electromagnetic coil according to the first aspect, wherein the covering (40) is preferably formed by a knitted material.

In a third aspect, the electromagnetic coil according to the first aspect, wherein the covering (40) is preferably formed by a stretchable nonwoven fabric.

In a fourth aspect, the electromagnetic coil according to any of the first to third aspects, wherein the covering (40) is preferably formed by a tape (41) which can be wound on the bobbinless coil (30).

In a fifth aspect, the electromagnetic coil according to the fourth aspect, wherein the tape (41) is preferably wound on the bobbinless coil (30) in at least two layers.

In a sixth aspect, the electromagnetic coil according to any of the first to fifth aspects, wherein the bobbinless coil (30) is secured in the accommodating groove (24) by means of the thermosetting resin.

In a seventh aspect, the electromagnetic coil according to the sixth aspect, wherein, preferably, the coil case (20) has a recess (27) which is indented from a side wall (26) defining the accommodating groove (24), and at least some of the thermosetting resin fills the recess (27).

In an eighth aspect, the present invention preferably provides an electromagnetic clutch (100) comprising: an electromagnetic coil (10) according to any of the first to seventh aspects;

a driving-side first rotator (101) formed by a magnetic material:
a driven-side second rotator (102) rotatable relative to the first rotator (101); and
an armature plate (103) which is formed by a magnetic material, is linked to the second rotator (102), and is disposed facing a side end face (101a) of the first rotator (101) with a gap (104) therebetween, characterized in that the electromagnetic coil (10) forms a magnetic circuit routed through the first rotator (101) and the armature plate (103) as a result of current passing through the bobbinless coil (30), and is accommodated in the interior of the first rotator (101) so as to be capable of generating an attraction force for electromagnetically attracting the armature plate (103) to the first rotator (101).

In a ninth aspect, the present invention furthermore provides a method for producing an electromagnetic coil (10) comprising:

a magnetic coil case (20) having an annular accommodating groove (24);
a bobbinless coil (30) accommodated directly in the accommodating groove (24);
a stretchable and resin-impregnatable covering (40) that covers the whole of the bobbinless coil (30); and
an electrical insulation layer (50) which is formed by an electrically-insulating thermosetting resin impregnating the covering (40), and covers a surface of the bobbinless coil (30), wherein the method for producing an electromagnetic coil (10) comprises:
a step of preparing the bobbinless coil (30);
after this, a step of covering the whole of the bobbinless coil (30) with the covering (40);
after this, a step of accommodating the bobbinless coil (30) covered by the covering (40) in the accommodating groove (24):
after this, a step of injecting an electrically-insulating liquid thermosetting resin (70) into the accommodating groove (24) to thereby impregnate the covering (40) with the liquid thermosetting resin (70); and
after this, a step of forming the electrical insulation layer (50) by heating and curing the liquid thermosetting resin (70) impregnating the covering (40).

### Effects of the Invention

The present invention makes it possible to provide technology enabling a reduction in the size and the weight of an electromagnetic coil.

### BRIEF DESCRIPTION OF THE DRAWINGS

FIG. 1 is a view in cross section of an electromagnetic coil according to an example.

FIG. 2 is an oblique view of a configuration in which the bobbinless coil shown in FIG. 1 is covered by the covering.

FIG. 3 is an enlargement in cross section, which is a cutaway of part of the configuration shown in FIG. 2 in which the bobbinless coil is covered by the covering.

FIG. 4 is a view in cross section along the line 4-4 in FIG. 3.

FIG. 5A is an explanatory diagram illustrating a winding step for the electromagnetic coil in accordance with an example; FIG. 5B is an explanatory diagram illustrating a holding step for the electromagnetic coil in accordance with an example; and FIG. 5C is an explanatory diagram illustrating a component connection preparation step for the electromagnetic coil in accordance with an example.

FIG. 6A is an explanatory diagram illustrating a covering step for the electromagnetic coil in accordance with an example; FIG. 6B is an explanatory diagram illustrating a connection step for the electromagnetic coil in accordance with an example; and FIG. 6C is an explanatory diagram illustrating an additional covering step for the electromagnetic coil in accordance with an example.

FIG. 7 is an explanatory diagram illustrating an accommodating step for the electromagnetic coil in accordance with an example.

FIG. 8 is an explanatory diagram illustrating a preheating step for the electromagnetic coil in accordance with an example.

FIG. 9 is an explanatory diagram illustrating an impregnation treatment step for the electromagnetic coil in accordance with an example.

FIG. 10 is an explanatory diagram illustrating a curing step for the electromagnetic coil in accordance with an example.

FIG. 11 is a view in cross section of an electromagnetic clutch comprising the electromagnetic coil shown in FIG. 1.

### EMBODIMENTS OF THE INVENTION

Embodiments of the present invention will be described below with reference to the appended drawings. It should be noted that the forms depicted in the appended drawings are examples of the present invention, and the present invention is not limited to those forms.

### EXAMPLE

An electromagnetic coil 10, an electromagnetic clutch 100 comprising the electromagnetic coil 10, and a method for producing the electromagnetic coil 10, according to an example, will be described with reference to the drawings.

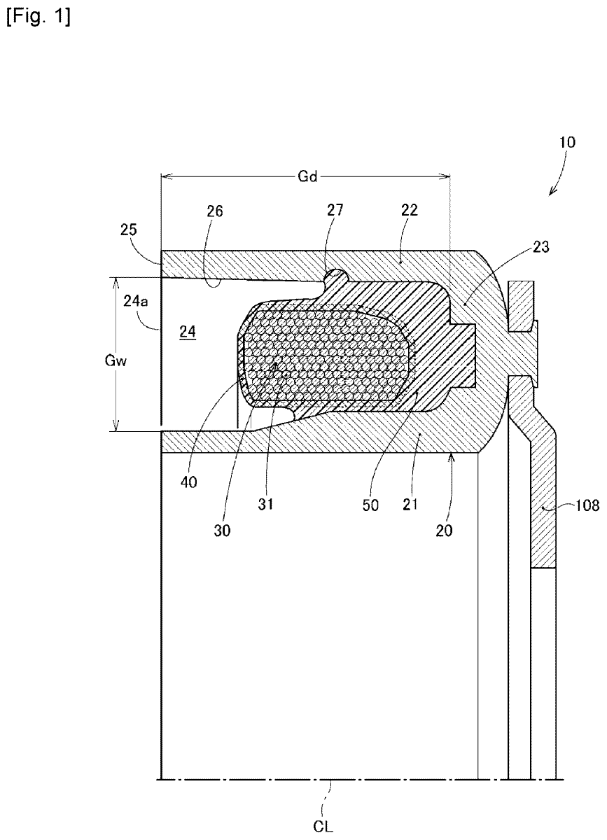

The electromagnetic coil 10 shown in FIG. 1 is used in an electromagnetic device such as an electromagnetic clutch or electromagnetic brake, for example. The electromagnetic coil 10 comprises: a magnetic coil case 20 having an annular shape centered on a center line CL; a coil 30 accommodated in the coil case 20; a stretchable and resin-impregnatable covering 40 that covers the whole of the coil 30; and an electrical insulation layer 50 which is formed by an electrically-insulating thermosetting resin impregnating the covering 40, and covers a surface of the coil 30.

The coil case 20 comprises an annular accommodating groove 24 having a U-shaped cross section which is open at one end, defined by an inner circumferential-side side wall 21, an outer circumferential-side side wall 22, and a bottom wall 23 closing off ends of the side walls 21, 22.

A face 25 of the coil case 20 on the opposite side to the bottom wall 23 is referred to as the open end face 25. An opening 24a of the accommodating groove 24 is positioned on the open end face 25 side (the opposite side to the bottom wall 23). A groove width Gw of the accommodating groove 24 is preferably such that the opening 24a is wide. A wider opening makes it easier for a liquid thermosetting resin (which will be described later) to be injected into the accommodating groove 24.

The coil 30 is accommodated directly in the accommodating groove 24 of the coil case 20 without a coil bobbin being interposed. That is to say, the coil 30 constitutes a bobbinless coil without a coil bobbin. The coil 30 may be referred to below as the “bobbinless coil 30”. The bobbinless coil 30 is formed by coil windings 31 which are copper wires or the like. The bobbinless coil 30 is preferably formed with a square cross-sectional shape (including a substantially square cross-sectional shape) with tightly packed coil windings 31. The electrical insulation layer 50 on the opening 24a side of the accommodating groove 24 is formed only by the thickness of the covering 40 (including substantially only by the thickness of the covering 40), i.e., is formed only by the electrically-insulating thermosetting resin impregnating the covering 40.

The bobbinless coil 30 is secured in the accommodating groove 24 by means of the thermosetting resin 50 (electrical insulation layer 50). It is therefore possible to prevent the bobbinless coil 30 from becoming dislodged from the accommodating groove 24.

The coil case 20 comprises, on an inner face 26 (face 26 on the accommodating groove 24 side) of at least either one of the inner circumferential-side side wall 21 and the outer circumferential-side side wall 22, a recess 27 indented from that inner face 26. The recess 27 is formed over part or the whole of the circumference of the inner face 26.

The coil case 20 thus comprises the recess 27 which is indented from the side wall 21 of the accommodating groove 24. At least some of the thermosetting resin 50 (electrical insulation layer 50) fills the recess 27. At least some of the thermosetting resin 50 is taken into the recess 27, so the bobbinless coil 30 can be more securely prevented from becoming dislodged from the coil case 20.

As stated above, the covering 40 is formed by a stretchable and resin-impregnatable member.

The covering 40 is preferably formed by a knitted material, by way of example. The covering 40 is formed by a knitted material which is very stretchable in comparison with a woven material. The covering 40 is very stretchable and is therefore unlikely to become creased while covering the bobbinless coil 30, and is capable of closely contacting the bobbinless coil 30. The bobbinless coil 30 can be uniformly covered by the covering 40 which comprises a knitted material, and the covering 40 can also keep the liquid thermosetting resin impregnated therein. A uniform electrical insulation layer 50 can therefore be formed on the surface of the bobbinless coil 30.

As another example, the covering 40 is preferably formed by a stretchable nonwoven fabric. A stretchable nonwoven fabric such as “FELIBENDY” (registered trademark) manufactured by Kuraray Kuraflex Co., Ltd. may be cited as a preferred example of a stretchable nonwoven fabric. Furthermore, stretchable nonwoven fabric technology is known from JP 2012-012758 A (Title of the Invention: Stretchable nonwoven fabric with high elongation: Applicant: Kuraray Kuraflex Co., Ltd.).

The covering 40 is formed by a stretchable nonwoven fabric which is very stretchable in comparison with a woven material. The nonwoven fabric is very stretchable and is therefore unlikely to become creased while covering the bobbinless coil 30, and is capable of closely contacting the bobbinless coil 30. The bobbinless coil 30 can be uniformly covered by the covering 40 which comprises a nonwoven fabric, and the covering 40 can also keep the liquid thermosetting resin impregnated therein. A uniform electrical insulation layer 50 can therefore be formed on the surface of the bobbinless coil 30.

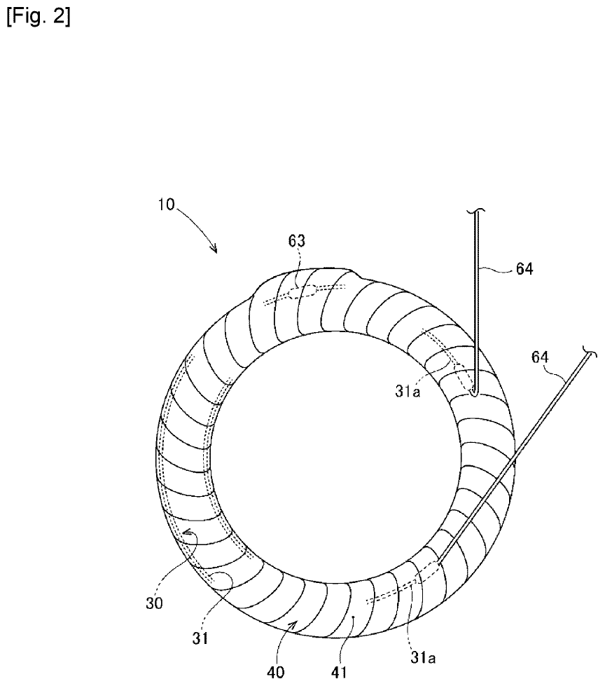

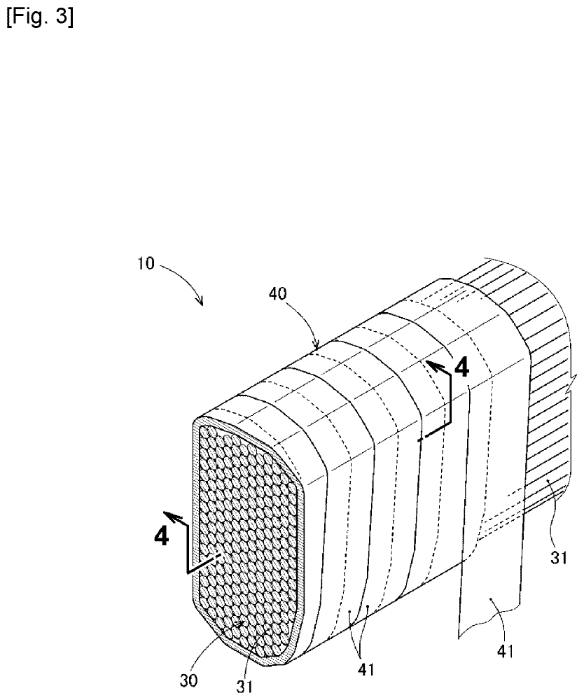

In addition, the covering 40 is formed by a tape 41 which can be wound on the bobbinless coil 30, as shown in FIGS. 2 and 3. The tape 41 is formed by a stretchable and resin-impregnatable member such as a knitted material or a stretchable nonwoven fabric. The whole of the bobbinless coil 30 can thus be covered by winding the tape 41 around the bobbinless coil 30. It is therefore easy to cover the bobbinless coil 30 in its entirety.

The covering 40 is wound around the bobbinless coil 30 with overlaps (wound in multiple layers), so that the amount of liquid thermosetting resin with which the covering 40 is impregnated can be easily and reliably managed. The required thickness of the electrical insulation layer 50 can be easily and reliably managed as a result.

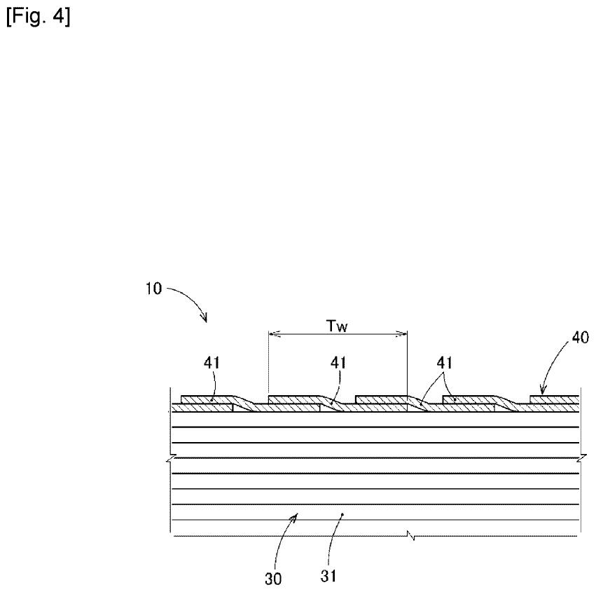

As shown in FIGS. 3 and 4, for example, the tape 41 is wound in multiple layers (at least two layers) around the bobbinless coil 30. For example, the tape 41 is preferably wound in multiple layers with overlaps of half of the tape width Tw. The tape 41 is wound in this way with overlaps of half of the tape width Tw, which therefore eliminates gaps between adjacent layers of the tape 41 and allows the electrical insulation layer 50 to be reliably formed on the outer circumference of the bobbinless coil 30.

The covering 40 is thus preferably in the form of a tape which is capable of covering the bobbinless coil 30 even more easily than a sheet. The covering 40 in the form of a tape which is capable of easily covering the bobbinless coil 30 is wound with overlaps, so the electrical insulation layer 50 can be formed without gaps, and the required thickness of the electrical insulation layer 50 can also be managed according to the number of overlaps of the covering 40. That is to say, by managing the thickness of the covering 40 that covers the bobbinless coil 30, the amount of liquid thermosetting resin impregnating the covering 40 can be easily and reliably managed. The required thickness of the electrical insulation layer 50 can be easily and reliably managed as a result.

As shown in FIG. 2, an accessory 63 such as a thermal fuse is connected to the bobbinless coil 30, as required, and external wiring 64 is connected to ends 31a, 31a (connecting ends 31a, 31a) of the coil windings 31. The thermal fuse blocks the passage of current to the bobbinless coil 30 by melting when the ambient temperature exceeds a predetermined value, for example.

A summary of the electromagnetic coil 10 described above is as follows.

As shown in FIG. 1, the electromagnetic coil 10 comprises: the magnetic coil case 20 having the annular accommodating groove 24; the bobbinless coil 30 accommodated directly in the accommodating groove 24; the elastic and resin-impregnatable covering 40 that covers the whole of the bobbinless coil 30; and the electrical insulation layer 50 which is formed by the electrically-insulating thermosetting resin impregnating the covering 40, and covers the surface of the bobbinless coil 30.

The main feature of the electromagnetic coil 10 according to this example that lies in the fact that the electrical insulation layer 50 is formed on the surface of the bobbinless coil 30 by impregnating the covering 40 with the electrically-insulating liquid thermosetting resin. That is to say, it is not the case with the electromagnetic coil 10 that the electrical insulation layer 50 is simply formed on the surface of the bobbinless coil 30 by a liquid thermosetting resin injected into the accommodating groove 24 of the coil case 20.

More specifically, the coil 30 is accommodated directly in the accommodating groove 24 of the coil case 20 without a coil bobbin being interposed. That is to say, the coil 30 constitutes a bobbinless coil 30 without a coil bobbin. The whole of the bobbinless coil 30 is covered by the stretchable and resin-impregnatable covering 40. The covering 40 is impregnated with the electrically-insulating liquid thermosetting resin. The electrical insulation layer 50 can be formed on the surface of the bobbinless coil 30 by means of the impregnating thermosetting resin. The covering 40 constitutes a substrate for forming and holding the electrical insulation layer 50. The electrical insulation layer 50 is formed by impregnating only the interior and the surface of the covering 40, and provides electrical insulation between the side walls 21, 22 (groove side walls 21, 22) defining the accommodating groove 24 of the coil case 20, and the surface of the bobbinless coil 30.

Electrical insulation can therefore be provided between the groove side walls 21, 22 and the bobbinless coil 30, without a coil bobbin being interposed. It is possible to achieve a reduction in the size and the weight of the electromagnetic coil 10 because there is no coil bobbin.

Moreover, the electrical insulation layer 50 is formed by impregnating only the interior and the surface of the covering 40 which serves as a substrate. The electrical insulation layer 50 can therefore be made thinner. For example, the electrical insulation layer 50 on the opening 24a side of the accommodating groove 24 is formed only by the thickness of the covering 40 (including substantially only by the thickness of the covering 40), i.e., is formed only by the electrically-insulating thermosetting resin impregnating the covering 40. There is no need for the electrically-insulating liquid thermosetting resin to completely fill the accommodating groove 24. The groove width Gw and groove depth Gd of the accommodating groove 24 can be set at small values. It is possible to achieve a reduction in the size and the weight of the electromagnetic coil 10 as a result.

Additionally, the covering 40 is stretchable, and is therefore unlikely to become creased while covering the bobbinless coil 30. Consequently, the covering 40 can be uniformly impregnated with the liquid thermosetting resin, and an electrical insulation layer 50 having a uniform thickness can be obtained.

A method for producing the electromagnetic coil 10 having the configuration above will be described next.

A summary of the configuration of the electromagnetic coil 10 in relation to an assembly method according to this example is as follows.

As shown in FIG. 1, the electromagnetic coil 10 comprises: the magnetic coil case 20 having the annular accommodating groove 24; the bobbinless coil 30 accommodated directly in the accommodating groove 24; the elastic and resin-impregnatable covering 40 that covers the whole of the bobbinless coil 30; and the electrical insulation layer 50 which is formed by the electrically-insulating thermosetting resin impregnating the covering 40, and covers the surface of the bobbinless coil 30.

The method for producing the electromagnetic coil 10 comprises the following steps.

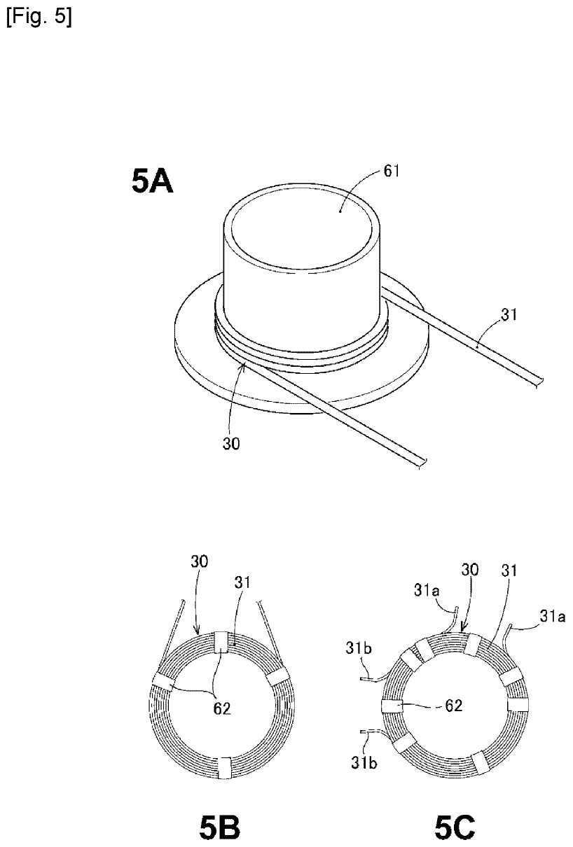

As shown in FIG. 5A, the coil windings 31 are first of all wound on a winding jig 61 by means of a winding machine (not depicted) in order to produce the bobbinless coil 30 (winding step).
After the winding step, as shown in FIG. 5B, the bobbinless coil 30 is removed from the winding jig 61 and held in a coiled state by means of a temporary fixing tape 62 (holding step).

After the holding step, as shown in FIG. 5C, the connecting ends 31a, 31a of the coil windings 31 are pulled out from the bobbinless coil 30 (component connection preparation step). The connecting ends 31a, 31a are parts for connecting the external wiring 64 (see FIG. 2). In the component connection preparation step when an accessory 63 (see FIG. 2) needs to be connected, a cut is made partway along the coil windings 31 of the bobbinless coil 30, and component connecting portions 31b, 31b (cut ends 31b, 31b) are pulled out from partway along the coil windings 31.

Preparation of the bobbinless coil 30 is completed by implementing the holding step and the component connection preparation step. A step of preparing the bobbinless coil 30 (preparation step) is achieved after the holding step and the component connection preparation step have been completed.

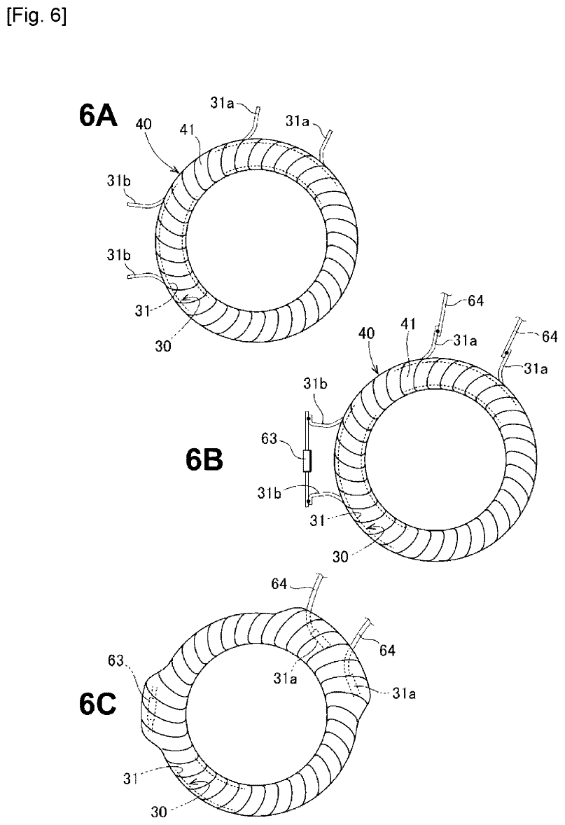

After the preparation step, as shown in FIG. 6A, the whole of the bobbinless coil 30, excluding the connecting ends 31a, 31a and the component connecting portions 31b, 31b, is covered with the covering 40 (covering step). The covering step may be carried out by winding the covering 40 comprising the tape 41 around the bobbinless coil 30, for example. Electrical insulation can be provided between the bobbinless coil 30 and the component connecting portions 31b, 31b by means of the covering step.

After the covering step, as shown in FIG. 6B, the external wiring 64 is connected to the connecting ends 31a, 31a of the coil windings 31 (connection step). The accessory 63 is furthermore connected to the component connecting portions 31b, 31b, as required, in the connection step.

After the connection step, as shown in FIG. 6C, the connecting ends 31a, 31a and the component connecting portions 31b, 31b are covered with the covering 40 (additional covering step). The additional covering step may be carried out, for example, by winding the covering 40 comprising the tape 41 around the bobbinless coil 30, including the connecting ends 31a, 31a, the component connecting portions 31b, 31b, and the accessory 63. The additional covering step makes it possible to provide electrical insulation between the coil case 20 and the connecting ends 31a, 31a and component connecting portions 31b, 31b. It should be noted that the accessory 63 and the external wiring 64 protrude to some extent from the outer circumferential surface of the bobbinless coil 30, so the covering 40 also bulges proportionately (the bulges have been enlarged for clarity in FIG. 6C).

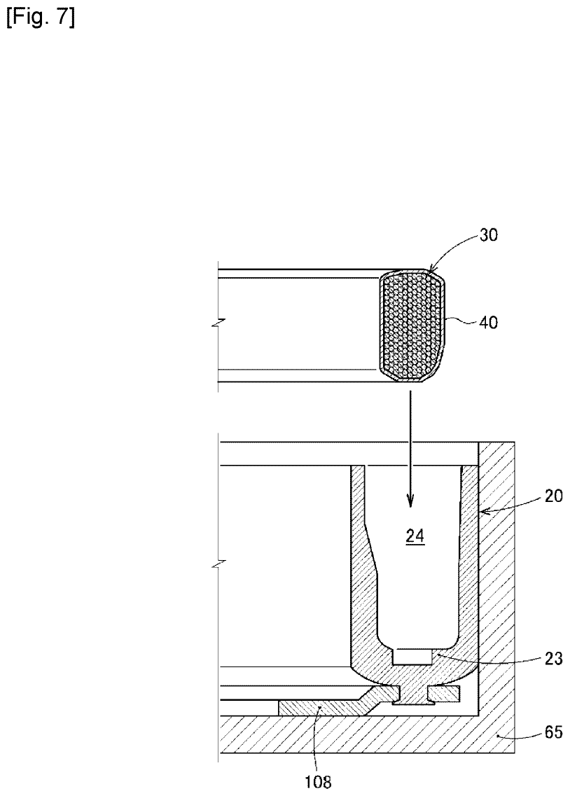

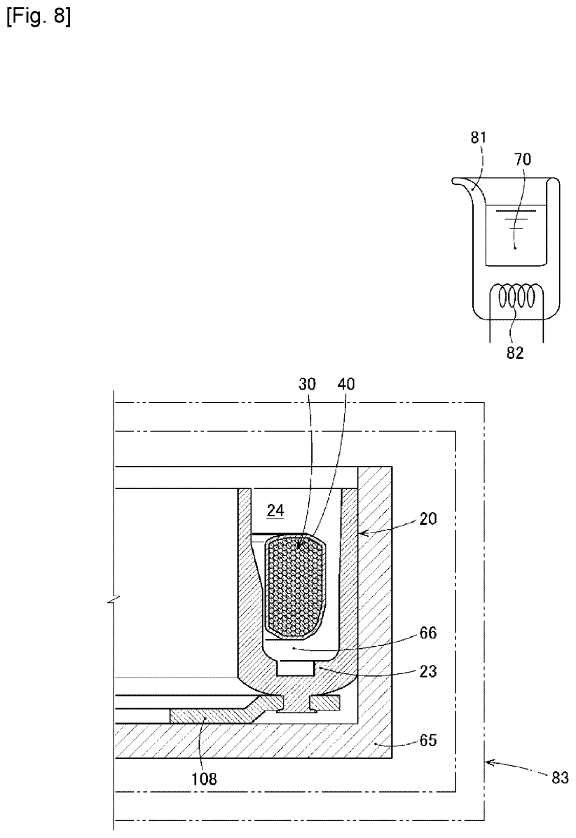

After the additional covering step, as shown in FIG. 7, the bobbinless coil 30 which is covered by the covering 40 is accommodated, i.e., set, in the accommodating groove 24 of the coil case 20 (accommodating step). In the accommodating step, the coil case 20 is already set in a case holding jig 65 (mounting jig 65). For example, a fixing plate 108 is pre-fixed to the bottom wall 23 of the coil case 20. The coil case 20 is set in the case holding jig 65 with the fixing plate 108 at the bottom. The accommodating groove 24 of the coil case 20 is therefore open at the top. It should be noted that the case holding jig 65 may be of any shape or size. The bobbinless coil 30 is accommodated in the accommodating groove 24 as a result of the accommodating step, as shown in FIG. 8. It should be noted that the accessory 63 and the external wiring 64 protrude to some extent from the outer circumferential surface of the bobbinless coil 30, as shown in FIG. 6C. An interval 66 (space 66) will therefore be present between the bobbinless coil 30 and the bottom wall 23 even if the bobbinless coil 30 is pushed into the accommodating groove 24, as shown in FIG. 8.

After the accommodating step, as shown in FIG. 8, the electrically-insulating liquid thermosetting resin 70 and the coil case 20 are preheated to maintain flowability of the thermosetting resin 70 (preheating step). For example, a container 81 containing the liquid thermosetting resin 70 is heated by means of a heater 82 to maintain the preheated state of the liquid thermosetting resin 70 and thereby maintain the flowability of the thermosetting resin. Furthermore, the coil case 20 after the accommodating step is introduced into a preheating oven 83 for preheating.

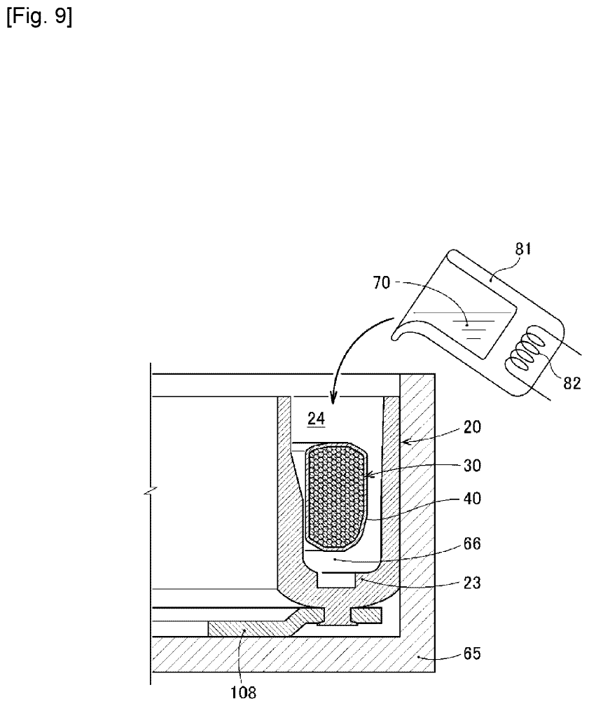

After the accommodating step and the preheating step, as shown in FIG. 9, the liquid thermosetting resin 70 is injected into the accommodating groove 24, whereby the covering 40 is impregnated with the liquid thermosetting resin (impregnation treatment step). For example, a preset fixed quantity of the liquid thermosetting resin 70 contained in the container 81 is poured into the accommodating groove 24, whereby the thermosetting resin 70 can be injected into the accommodating groove 24 (pouring process). A fixed time is allowed to pass after the injection so that the covering 40 is thoroughly impregnated with the liquid thermosetting resin 70.

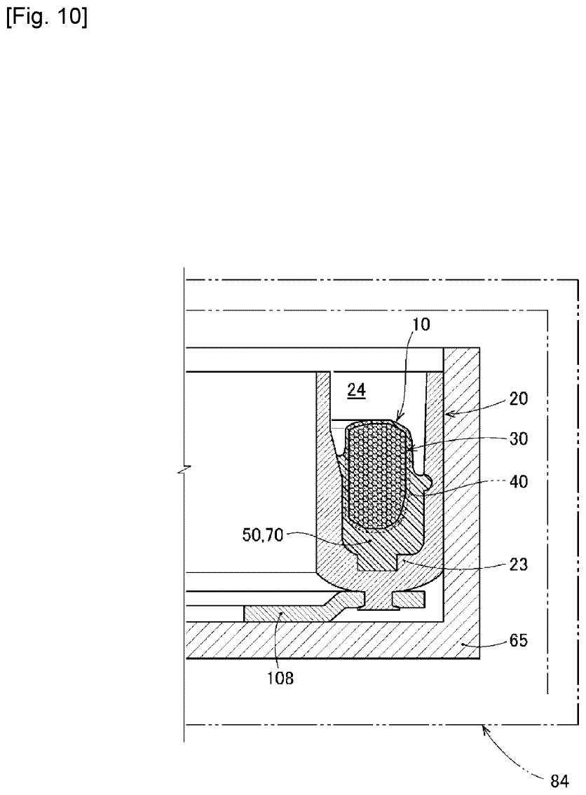

More specifically, the accommodating groove 24 of the coil case 20 is open at the top, as stated above. When the fixed quantity of the liquid thermosetting resin 70 is poured into the accommodating groove 24, as shown in FIG. 10, roughly the bottom half of the bobbinless coil 30 covered by the covering 40 is immersed in the liquid thermosetting resin 70. Roughly the upper half of the bobbinless coil 30 and the covering 40 is impregnated with the liquid thermosetting resin 70 poured into the accommodating groove 24. The covering 40 is thoroughly impregnated with the liquid thermosetting resin 70 as a result. Accordingly, there is no need to completely fill the accommodating groove 24 with the liquid thermosetting resin 70.

After the impregnation treatment step, as shown in FIG. 10, the liquid thermosetting resin 70 impregnating the covering 40 is heated and cured to thereby form the electrical insulation layer 50 (curing step). For example, the liquid thermosetting resin 70 impregnating the covering 40 is cured by heating the coil case 20 after the impregnation treatment step in a curing and heating oven 84.

After the curing step, the coil case 20 is cooled to normal temperature, completing the series of steps for producing the electromagnetic coil 10.

A summary of the method for producing the electromagnetic coil 10 described above is as follows.

The method for producing the electromagnetic coil 10 comprises:

a step of preparing the bobbinless coil 30 (preparation step shown in FIG. 5A-5C);
after this, a step of covering the whole of the bobbinless coil 30 with the covering 40 (covering step shown in FIG. 6A);
after this, a step of accommodating the bobbinless coil 30 covered by the covering 40 in the accommodating groove 24 (accommodating step shown in FIG. 7);
after this, a step of injecting the electrically-insulating liquid thermosetting resin 70 into the accommodating groove 24 to thereby impregnate the covering 40 with the liquid thermosetting resin 70 (impregnation treatment step shown in FIG. 9); and
after this, a step of forming the electrical insulation layer 50 by heating and curing the liquid thermosetting resin 70 impregnating the covering 40 (curing step shown in FIG. 10).

The main feature of the method for producing the electromagnetic coil 10 according to this example that lies in the fact that the electrical insulation layer 50 is formed on the surface of the bobbinless coil 30 by impregnating the covering 40 with the electrically-insulating liquid thermosetting resin 70. That is to say, it is not the case that the electrical insulation layer 50 is formed on the surface of the bobbinless coil 30 simply by injecting the liquid thermosetting resin 70 into the accommodating groove 24 of the coil case 20.

More specifically, the bobbinless coil 30 which is completely covered by the stretchable covering 40 is accommodated in the accommodating groove 24 of the coil case 20 and the liquid thermosetting resin 70 is injected into the accommodating groove 24. The covering 40 can be impregnated with the thermosetting resin 70 by this means. After this, the electrical insulation layer 50 can be formed on the surface of the bobbinless coil 30 by heating and curing the impregnating thermosetting resin 70. The covering 40 constitutes a substrate for forming and holding the electrical insulation layer 50. As shown in FIG. 1, the electrical insulation layer 50 is formed by impregnating only the interior and the surface of the covering 40, and provides electrical insulation between the side walls 21, 22 (groove side walls 21, 22) defining the accommodating groove 24 of the coil case 20, and the surface of the bobbinless coil 30. It is possible to achieve a reduction in the size and the weight of the electromagnetic coil 10 by dispensing with the coil bobbin.

Moreover, it is only the interior and the surface of the covering 40 serving as a substrate which can be impregnated with the thermosetting resin 70. The thermosetting resin 70 can therefore be made thinner. For example, the electrical insulation layer 50 on the opening 24a side of the accommodating groove 24 is formed only by the thickness of the covering 40 (including substantially only by the thickness of the covering 40), i.e., is formed only by the electrically-insulating thermosetting resin impregnating the covering 40. There is no need for the electrically-insulating thermosetting resin 70 to completely fill the accommodating groove 24. The groove width Gw and groove depth Gd of the accommodating groove 24 can be set at small values. It is possible to achieve a reduction in the size and the weight of the electromagnetic coil 10 as a result.

Additionally, the covering 40 is stretchable, and is therefore unlikely to become creased while covering the bobbinless coil 30. Consequently, the covering 40 can be uniformly impregnated with the thermosetting resin 70, and an electrical insulation layer 50 having a uniform thickness can be obtained.

A configuration in which the electromagnetic coil 10 having the configuration above (including the electromagnetic coil 10 in accordance with the production method above) is provided in an electromagnetic clutch 100 will be described next.

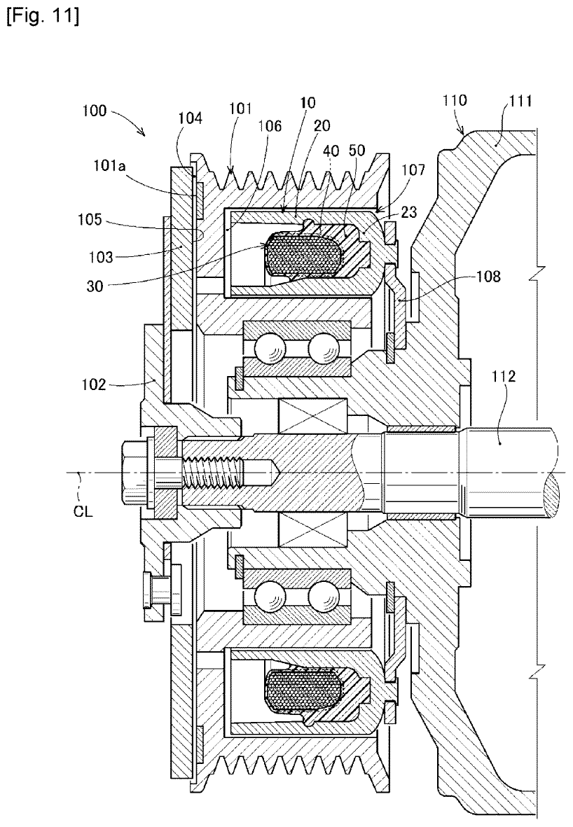

As shown in FIG. 11, the electromagnetic clutch 100 is a mechanical component provided in a gas compressor 110, which is a component of a refrigeration cycle in a vehicle air conditioning device, and transmits or blocks power to the gas compressor 110. The gas compressor 110 comprises: a rotary shaft 112 rotatably supported by a housing 111; and a compression mechanism (not depicted) accommodated in the housing 111 and driven by means of the rotary shaft 112.

The electromagnetic clutch 100 comprises: the electromagnetic coil 10; a driving-side first rotator 101 formed by a magnetic material; a driven-side second rotator 102 rotatable relative to the first rotator 101; and an armature plate 103 linked to the second rotator 102.

The second rotator 102 is mounted on the rotary shaft 112 extending outward from the housing 111, in such a way that relative rotation is restricted.

The first rotator 101 is a member having an annular shape centered on the center line CL of the rotary shaft 112, and is rotatably supported by the housing 111 and positioned radially outward of the rotary shaft 112. The first rotator 101 can receive power input from an external rotational power source such as an engine or electric motor, and is constructed by a pulley, for example.

The armature plate 103 is formed by a magnetic material, is fixed to the second rotator 102, and is disposed facing a side end face 101a (friction face 101a) of the first rotator 101 with a gap 104 therebetween. More specifically, the armature plate 103 has a friction face 105 opposite the side end face 101a of the first rotator 101.

The first rotator 101 has an accommodating space 106 for accommodating the electromagnetic coil 10. The accommodating space 106 is a space having an annular shape centered on the center line CL of the rotary shaft 112 and opens on the opposite side to the side end face 101a. The coil case 20 of the electromagnetic coil 10 is accommodated at a fixed interval 107 from the accommodating space 106. The first rotator 101 is therefore rotatable without sliding against the coil case 20. The bottom wall 23 of the coil case 20 of the electromagnetic coil 10 is fixed to the housing 111 by means of the fixing plate 108.

A summary of the electromagnetic clutch 100 comprising the electromagnetic coil 10 described above is as follows.

As shown in FIG. 11, the electromagnetic clutch 100 comprises:

the electromagnetic coil 10;
the driving-side first rotator 101 formed by a magnetic material;
the driven-side second rotator 102 rotatable relative to the first rotator 101; and
the armature plate 103 which is formed by a magnetic material, is linked to the second rotator 102, and is disposed facing the side end face 101a of the first rotator 101 with a gap 104 therebetween.

The electromagnetic coil 10 forms a magnetic circuit routed through the first rotator 101 and the armature plate 103 as a result of current passing through the bobbinless coil 30, and is accommodated in the interior of the first rotator 101 so as to be capable of generating an attraction force for electromagnetically attracting the armature plate 103 to the first rotator 101.

The size and weight of the electromagnetic clutch 100 can be reduced because it comprises the compact and lightweight electromagnetic coil 10.

It should be noted that the electromagnetic coil 10, the electromagnetic clutch 100 comprising the electromagnetic coil 10, and the method for producing the electromagnetic coil 10 according to the present invention are not limited to the examples, provided that the actions and effects of the present invention are demonstrated.

For example, the electromagnetic coil 10 according to the present invention (including the electromagnetic coil 10 in accordance with the production method of the present invention) is not limited to a configuration in which it is provided in the electromagnetic clutch 100, and it may be provided in various types of electromagnetic devices such as an electromagnetic brake while still demonstrating an equivalent effect to that of the electromagnetic clutch 100.

Furthermore, the covering step (see FIG. 6A) in the method for producing the electromagnetic coil 10 should enable the whole of the bobbinless coil 30 to be covered by the covering 40, but it is optional whether or not this also includes covering the connecting ends 31a, 31a and the component connecting portions 31b, 31b. To give an example, it is also possible for the connecting step (see FIG. 6B) to be performed first, and then for the covering step (see FIG. 6A) and the additional covering step (see FIG. 6C) to be performed simultaneously. In this way, the connecting ends 31a, 31a and the component connecting portions 31b, 31b shown in FIG. 6C may also be covered together with the whole of the bobbinless coil 30 in the covering step shown in FIG. 6A.

### INDUSTRIAL APPLICABILITY

The electromagnetic coil 10 of the present invention (including the electromagnetic coil 10 in accordance with the present invention), and the electromagnetic clutch 100 comprising the electromagnetic coil 10 are suitable for use in a compressor of a vehicle air conditioning device.

### KEY TO SYMBOLS

10 Electromagnetic coil
20 Coil case
21 Inner circumferential-side side wall
22 Outer circumferential-side side wall
24 Accommodating groove
26 Inner face (face on accommodating groove side)
27 Recess
30 Bobbinless coil
31 Coil windings
40 Covering
41 Tape
50 Electrical insulation layer (thermosetting resin)
70 Liquid thermosetting resin
100 Electromagnetic clutch
101 Driving-side first rotator
101a Side end face
102 Driven-side second rotator
103 Armature plate
104 Gap
110 Gas compressor

1. An electromagnetic coil comprising:
a magnetic coil case having an annular accommodating groove;
a bobbinless coil accommodated directly in the accommodating groove;
a stretchable and resin-impregnatable covering that covers the whole of the bobbinless coil; and
an electrical insulation layer which is formed by an electrically-insulating thermosetting resin impregnating the covering, and covers a surface of the bobbinless coil.

2. The electromagnetic coil as claimed in claim 1, wherein the covering is formed by a knitted material.

3. The electromagnetic coil as claimed in claim 1, wherein the covering is formed by a stretchable nonwoven fabric.

4. The electromagnetic coil as claimed in claim 1, wherein the covering is formed by a tape which can be wound on the bobbinless coil.

5. The electromagnetic coil as claimed in claim 4, wherein the tape is wound on the bobbinless coil in at least two layers.

6. The electromagnetic coil as claimed in claim 1, wherein the bobbinless coil is secured in the accommodating groove by the thermosetting resin.

7. The electromagnetic coil as claimed in claim 6, wherein the coil case has a recess which is indented from a side wall defining the accommodating groove, and at least some of the thermosetting resin fills the recess.

8. An electromagnetic clutch comprising:
an electromagnetic coil as claimed in claim 1;
a driving-side first rotator formed by a magnetic material;
a driven-side second rotator rotatable relative to the first rotator; and
an armature plate which is formed by a magnetic material, is linked to the second rotator, and is disposed facing a side end face of the first rotator with a gap therebetween,
wherein the electromagnetic coil forms a magnetic circuit routed through the first rotator and the armature plate as a result of current passing through the bobbinless coil, and is accommodated in an interior of the first rotator so as to be capable of generating an attraction force for electromagnetically attracting the armature plate to the first rotator.

9. A method for producing an electromagnetic coil comprising:
a magnetic coil case having an annular accommodating groove;
a bobbinless coil accommodated directly in the accommodating groove;
a stretchable and resin-impregnatable covering that covers the whole of the bobbinless coil; and
an electrical insulation layer which is formed by an electrically-insulating thermosetting resin impregnating the covering, and covers a surface of the bobbinless coil,
wherein the method for producing an electromagnetic coil comprises:
preparing the bobbinless coil;
covering the whole of the bobbinless coil with the covering;
accommodating the bobbinless coil covered by the covering in the accommodating groove;
injecting an electrically-insulating liquid thermosetting resin into the accommodating groove to thereby impregnate the covering with the liquid thermosetting resin; and
forming the electrical insulation layer by heating and curing the liquid thermosetting resin impregnating the covering.
